(19) United States
(12) Patent Application Publication
(10) Pub. No.: US 2006/0041913 A1
(43) Pub. Date: Feb. 23, 2006

(54) Video head unit system for automobile

(75) Inventor: Bong-Keun Song, Anyang-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/167,105

(22) Filed: Jun. 28, 2005

(30) Foreign Application Priority Data
Aug. 17, 2004 (KR) 2004-64740

(51) Int. Cl. H04N 7/18

(52) U.S. Cl. 725/75

(57) ABSTRACT

A video head unit system for automobiles includes a head unit that receives a plurality of external video signals and controls outputs of the external video signals, and front and rear LCD monitors that display the external video signals based on control signals from the head unit.

### RELATED APPLICATIONS

The present disclosure relates to subject matter contained in Korean Application No. 10-2004-0064740, filed on Aug. 17, 2004, which is herein expressly incorporated by reference its entirety.

### BACKGROUND OF THE INVENTION

1. Field of the Invention

The present invention relates to a video head unit system for automobiles, and more particularly to a video head unit system for automobiles, wherein a single CPU of a head unit can freely control front and rear LCD monitors and all operations are performed by only the CPU of the head unit when a user manipulates the system, the response speed of the system is very high and the software of the system can be easily upgraded.

2. Description of the Related Art

FIG. 1 is a block diagram illustrating the configuration of an existing video head unit system for automobiles.

Referring to FIG. 1, the existing video head unit system for automobiles is composed of a rear control unit (RCU) 40 for receiving a plurality of external video signals and controlling outputs of the external video signals, a head unit 10 for controlling the rear control unit 40, and a front liquid crystal display (LCD) 20 and a rear LCD 30 for displaying the external video signals under the control of the rear control unit 40.

Particularly, the head unit 10, the front LCD 20, the rear LCD 30, and the rear control unit 40 contain respective CPUs and respective memories.

In operation of the existing video head unit system for automobile as configured above, the rear control unit 40 multiplexes a video signal from the head unit 10 and N external video signals and transmits the multiplexed signals to the front and rear LCDs 20 and 30 for displaying the external video signals.

In addition, the front and rear LCDs 20 and 30 generate respective A/Vs and air conditioning human machine interfaces (HMI).

In addition, the head unit generates an HMI for exclusive use in MTS and controls the RCU to switch over the video signals through a MOST connection.

In addition, the head unit controls the front and rear LCDs through a CAN connection to display proper HMIs while maintaining the same state as the head unit.

However, since components of the existing head unit system for automobiles, as configured above, have respective CPUs and communication between components is conducted, the overall cost of the system is very high. In addition, since all operations are performed by the communication between components when a user manipulates the system, the response speed of the system is very low. Furthermore, there is a problem in that software loaded in the components must be separately upgraded.

### SUMMARY OF THE INVENTION

Therefore, the present invention has been made in view of the above problems, and it is an object of the present invention to provide a video head unit system for automobiles, wherein a single CPU of a head unit can freely control front and rear LCD monitors and all operations are performed by only the CPU of the head unit when a user manipulates the system, the response speed of the system is very high and software of the system can be easily upgraded.

In accordance with an aspect of the present invention, the above and other objects can be accomplished by the provision of a video head unit system for automobiles, comprising: a head unit for receiving a plurality of external video signals and controlling outputs of the external video signals; and front and rear LCD monitors for displaying the external video signals based on control signals from the head unit.

Preferably, the head unit includes a multiplexer for multiplexing N external video signals to select two output signals; a first graphic controller for receiving one of the two output signals from the multiplexer and outputting the one output signal to the front LCD monitor; a second graphic controller for receiving the other of the two output signals from the multiplexer and outputting the other output signal to the rear LCD monitor; and a microcomputer for controlling the first and second graphic controllers to output the external video signals to the front and rear LCD monitors, respectively.

Preferably, the head unit supports the front and rear LCD monitors to control an MTS HMI, A/V, and air conditioning HMI, independently.

With this configuration, since a single CPU of a head unit can freely control the front and rear LCD monitors and all operations are performed by only the CPU of the head unit when a user manipulates the system, the response speed of the system is very high and the software of the system can be easily upgraded.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the configuration of an existing video head unit system for automobiles;

FIG. 2 is a simplified block diagram of a video head unit system for automobiles in accordance with the present invention; and

FIG. 3 is a block diagram illustrating the configuration of a video head unit system for automobiles in accordance with the present invention.

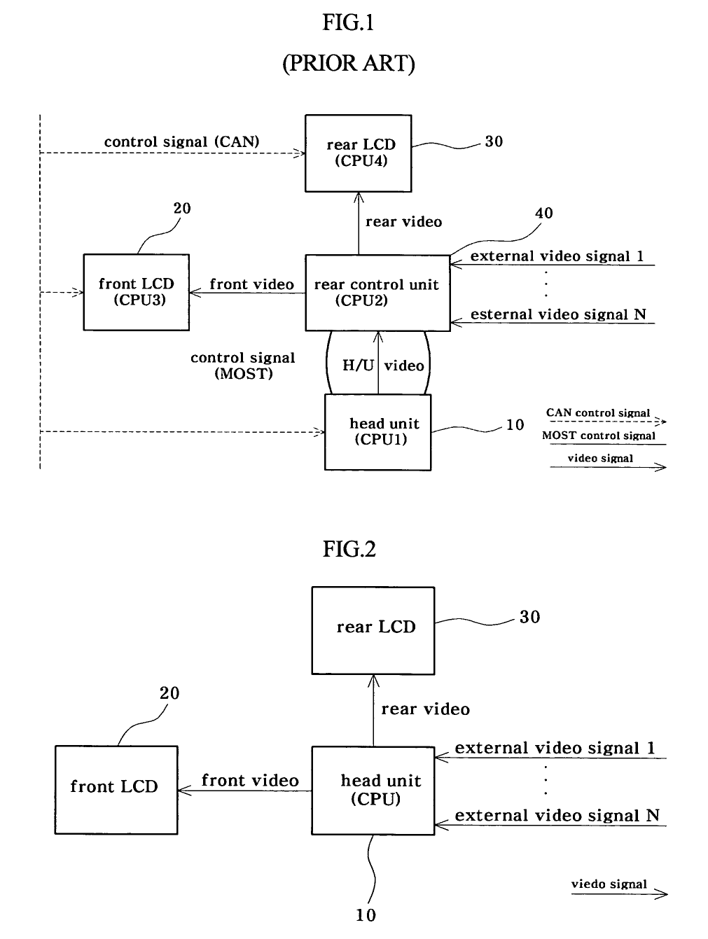

### DESCRIPTION OF THE PREFERRED EMBODIMENTS

Hereinafter, a preferred embodiment of the present invention will be described in detail with reference to the accompanying drawings.

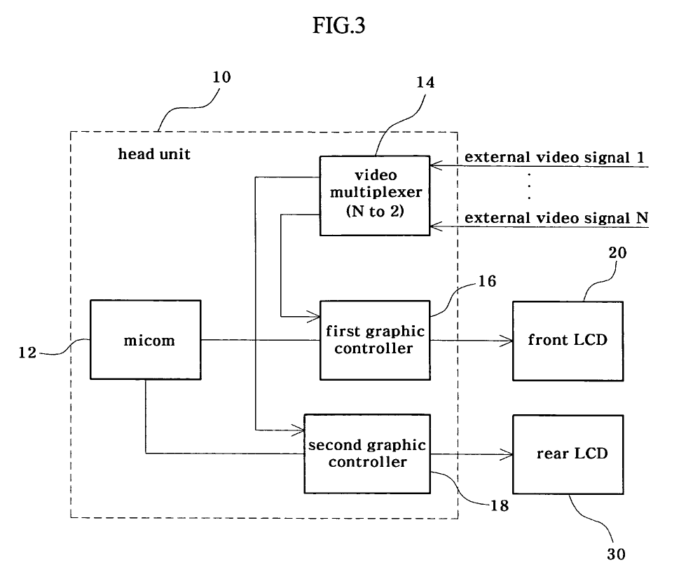

FIG. 2 is a simplified block diagram of a video head unit system for automobiles in accordance with the present invention, and FIG. 3 is a block diagram illustrating the configuration of a video head unit system for automobiles in accordance with the present invention.

Referring to FIG. 2, a video head unit system for automobiles in accordance with the present invention comprises a head unit 10 for receiving a plurality of external video signals and controlling outputs of the external video signals, and a front LCD monitor 20 and a rear LCD monitor 30 for displaying the external video signals based on control signals from the head unit 10.

Referring to FIG. 3, particularly, the head unit 10 includes a multiplexer 14 for multiplexing N external video signals to select two output signals, a first graphic controller 16 for receiving one of the two output signals from the multiplexer 14 and outputting the one output signal to the front LCD monitor 20, a second graphic controller 18 for receiving the other of the two output signals from the multiplexer 14 and outputting the other output signal to the rear LCD monitor 30, and a microcomputer 12 for controlling the first and second graphic controllers 16 and 18 to output the external video signals to the front and rear LCD monitors 20 and 30, respectively.

Namely, the video head unit system for automobiles in accordance with the present invention is a simple LCD display device where only the head unit 10 has a CPU, i.e., the microcomputer 12, but the front LCD monitor 20 and the rear LCD monitor 30 have no CPU. In addition, the head unit 10 supports the front and rear LCD monitors 20 and 30 to control an MTS HMI, A/V, and air conditioning HMI, independently.

As configured above, the head unit 10 contains the multiplexer 14 for multiplexing N external video signals to select two output signals, which are coupled to the two graphic controllers 16 and 18, respectively, connected to the front LCD monitor 20 and the rear LCD monitor 30 for displaying the external video signals, respectively.

In addition, the microcomputer 12 controls the two independent graphic controllers 16 and 18 to output the external video signals to the front LCD monitor 20 and the rear LCD monitor 30.

With the above configuration, production costs of a video head unit system for automobile can be significantly reduced by replacing the existing CPUs installed in every component with one CPU (microcomputer) at the head unit.

In addition, the head unit directly displays the HMI, which has been previously displayed on the front/rear LCD monitors. Accordingly, since the front/rear LCD monitors or the rear control unit (RCU) are not controlled through the CAN network or the MOST network, unlike the existing system, it is easy to develop a video head unit system for automobile and network connection devices may be omitted, which results in further reduction of production and development costs.

In addition, since a single microcomputer controls the front/rear LCD monitors, it is very easy to upgrade software of front/rear HMIs, and HMI control logic of the head unit becomes very simple.

As apparent from the above description, the present invention provides a video head unit system for automobile, which is capable of significantly reducing production costs of the video head unit system by replacing the existing CPUs installed at every component with one CPU (microcomputer) of the head unit.

In addition, the head unit directly displays the HMI, which has been previously displayed on the front/rear LCD monitors. Accordingly, since the front/rear LCD monitors or the rear control unit (RCU) are not controlled through the CAN network or the MOST network, unlike the existing system, it is easy to develop a video head unit system for automobile and network connection devices may be omitted, which results in further reduction of production and development costs.

In addition, since a single microcomputer controls the front/rear LCD monitors, it is very easy to upgrade software of the head unit, and HMI control logic of the head unit becomes very simple.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A video head unit system for automobiles, comprising:
a head unit that receives a plurality of external video signals and controls outputs of the external video signals; and
front and rear LCD monitors that display the external video signals based on control signals from the head unit.

2. The video head unit system as set forth in claim 1, wherein the head unit comprises:
a multiplexer that multiplexes N external video signals to select two output signals;
a first graphic controller that receives one of the two output signals from the multiplexer and outputs the one output signal to the front LCD monitor;
a second graphic controller that receives the other of the two output signals from the multiplexer and outputs the other output signal to the rear LCD monitor; and
a microcomputer that controls the first and second graphic controllers to output the external video signals to the front and rear LCD monitors, respectively.

3. The video head unit system as set forth in claim 1, wherein the head unit supports the front and rear LCD monitors to control an MTS HMI, A/V, and air conditioning HMI, independently.
